(19) United States
(12) Patent Application Publication
(10) Pub. No.: US 2013/0092290 A1
(43) Pub. Date: Apr. 18, 2013

(54) Anti-siphon and strainer fuel filler assembly and method of manufacturing the same

(71) Applicants: Evan Waymire, Oregon City, OR (US); John Loffink, Damascus, OR (US); Tim Barker, Legrande, OR (US)

(72) Inventors: Evan Waymire, Oregon City, OR (US); John Loffink, Damascus, OR (US); Tim Barker, Legrande, OR (US)

(21) Appl. No.: 13/317,318

(22) Filed: Oct. 14, 2011

(51) Int. Cl. B60K 15/04; B23P 11/00; B01D 35/30

(52) U.S. Cl. 141/286; 220/86.2; 29/896.62; 29/428

(57) ABSTRACT

One embodiment of an anti-siphon and strainer fuel filler assembly includes a fuel filler tube adapted for placement in a fuel tank opening, the fuel filler tube having a strainer structure positioned therein, the strainer structure including a cylindrical tube and a circular shaped end plate, the cylindrical tube and the circular shaped end plate each including a plurality of strainer structure apertures sized to prevent debris from flowing there through and into a fuel tank in which the fuel filler assembly is placed.

### BACKGROUND OF THE INVENTION

The present invention is particularly intended for use on fuel tanks on commercial vehicles, although it may be used on any fuel tank connected to any type of engine. Fuel tanks typically include a filler tube inlet or opening through which fuel is filled into the fuel tank. On commercial vehicles the fuel tanks may be quite large. Due to high cost of fuel, these large fuel tanks may be susceptible to illegal siphoning of the fuel from the fuel tank. Moreover, due to the large openings of the fuel tanks, and due to vandalism, debris may enter the fuel tank through the filler tubes.

Siphoning of fuel from a fuel tank generally involves placing a hose through the filler tube inlet or opening and down into the fuel held within the fuel tank. A suction pressure is then applied to the opposite end of the hose such that fuel within the tank flows upwardly and out of the tank through the hose. Siphoning generally cannot be accomplished if the hose cannot be placed downwardly into the tank and into the fuel held within the tank.

In order to prevent siphoning of fuel from fuel tanks, anti-siphon devices have been developed. One such anti-siphon device is described in U.S. Pat. No. 7,040,360, entitled Anti-Siphon Fuel Filler Assembly and Method of Manufacturing the Same, which includes an anti-siphon insert placed within an end of a fuel filler assembly. However, such anti-siphon inserts do not inhibit small debris from flowing though the filler tube and into the fuel tank.

There is a need, therefore, for a structure for inhibiting the flow of debris into a fuel tank.

### SUMMARY OF THE INVENTION

One embodiment of an anti-siphon and strainer fuel filler assembly includes a filler tube having a first end region adapted to be positioned in a fuel tank, the first end region including an aperture sized to allow fuel to flow through the aperture and out of the filler tube, the filler tube including a first crimp and a second crimp therein; a support structure positioned within the first end region of the filler tube, the support structure including a plurality of support structure apertures for allowing fuel to flow there through; and a strainer structure positioned in the filler tube and including strainer apertures extending there though that are sized for allowing fuel to flow there through while inhibiting debris from passing there through, the strainer and the support structure both retained within the filler tube by the first and the second crimps.

### BRIEF DESCRIPTION OF THE DRAWINGS

FIG. 1 is an isometric view of one embodiment of an anti-siphon and strainer fuel filler assembly of the present invention.

FIG. 2 is a cross-sectional side view of the anti-siphon and strainer fuel filler assembly taken along line 2-2 of FIG. 1, and shown installed on a fuel tank.

FIG. 3 is an end view of the anti-siphon and strainer fuel filler assembly taken along line 3-3 of FIG. 1.

FIG. 4 is a side view of a strainer tube including a plurality of strainer apertures.

FIG. 5 is a top view of a strainer end plate including a plurality of strainer apertures.

### DETAILED DESCRIPTION OF THE PREFERRED EMBODIMENTS

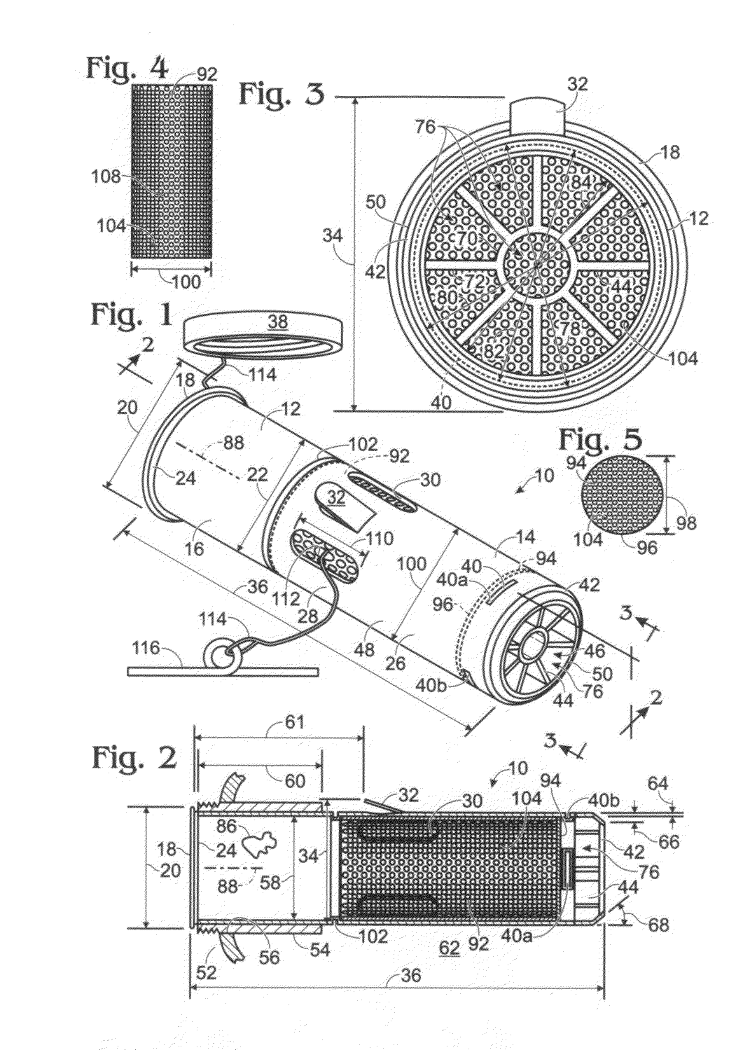

FIG. 1 is an isometric view of one embodiment of an anti-siphon and strainer fuel filler assembly of the present invention. Fuel filler assembly 10 in the embodiment shown comprises an elongate cylindrical body portion 12 including a first end region 14 and a second end region 16. First end region 14 is adapted to be received within a nozzle receiving opening of a fuel tank (see FIG. 2) and second end region 16 is adapted to extend outwardly from or be positioned flush with a fuel tank opening (see FIG. 2). In other embodiments, other arrangements or placements of fuel filler assembly 10 may be utilized. Second end region 16 may include a lip 18 or another type of outwardly extending projection so as to secure the tube against movement through the opening and into the fuel tank (see FIG. 2). Accordingly, lip 18 may have an outer diameter 20 that is greater than an outer diameter 22 of body portion 12 of assembly 10. An O-ring 24 may be placed around an exterior 26 of body 12 and adjacent lip 18 to provide a seal between lip 18 and the opening of a fuel tank (see FIG. 2) when the assembly is secured thereto.

Body 12, in a central region 28 thereof, may include a plurality of filler tube openings or apertures 30 which may allow fluid and/or air to pass therethrough. Central region 28 may further include one or more retaining or deflection members, such as a tang 32, extending outwardly from body 12. Tangs 32 may be cut from body 12 so as to define additional openings 30 within a side wall of filler tube body 12 that allow air/or and fluid to flow there through. Tang 32 generally extends outwardly from body 12 in an upper region of assembly 10, toward second region 16 of body 12, such that tang 32 acts to retain body 12 within a fuel tank once assembly 10 is inserted therein. In particular, tang 32 extends outwardly from body 12 to define a diameter 34 (see FIG. 2) that may be larger than the diameter of an opening (see FIG. 2) of a fuel tank such that assembly 10 is not easily removed from the opening in the direction through which the assembly was inserted. Accordingly, tang 32 and lip 18 together generally will retain assembly 10 in place on a fuel tank and against tampering or removal of the assembly from the fuel tank after installation thereof.

Body 12 of assembly 10, in the embodiment shown, is manufactured by the process of extrusion, such that body 12 may be seamless along its length 36. Lip 18, apertures 30 and tang 32 may be formed in body 12 after the extrusion process. Body 12 may be manufactured of aluminum but any durable material such as steel or heavy duty plastic may be utilized.

Still referring to FIG. 1, first end region 14 of body 12 may include a first crimp 40 and a second crimp 42 which may secure an anti-siphon insert 44 within an interior 46 of body 12. Anti-siphon insert 44 may also be referred to herein as a support structure 44 for supporting and retaining in place a strainer structure, as will be described more fully below. First crimp 40 may comprise a set of crimped regions, two of which, 40a and 40b, are visible in this figure, that may each extend at least partially around a perimeter 48 of body 12. In the embodiment shown, perimeter 48 defines a circumference of cylindrical body 12. First crimps 40a and 40b may be indented or inwardly protruding regions of body 12 that extend partially into interior 46 of body 12 such that crimped regions 40a and 40b define an inner diameter (see FIG. 3) that is smaller than an inner diameter (see FIG. 3) of body 12.

In the embodiment shown, length 36 of body 12 may be in a range of approximately seven to twelve inches, and first crimps 40a and 40b may be positioned approximately % of an inch from a lower end 50 of body 12. Crimps 40a and 40b may extend into interior 46 of body 12 approximately 1/16 of an inch. First crimp 40, including 40a and 40b, may be added to body 12 after extrusion of body 12. Projection of first crimp 40 into interior 46 of body 12 only through a potion of interior 46, such as only 1/16 of an inch, generally requires less compression force than completely compressing body 12 across its diameter. Accordingly, the crimping process of the present invention requires reduced sized crimping machinery than the heavy duty compressing machinery of prior art devices. Accordingly, the present invention has reduced manufacturing costs when compared to prior art anti-siphon assemblies.

Second crimp 42 may comprise a crimped region that extends completely around perimeter 48 at lower end 50 of body 12. Second crimp 42 may be manufactured on body 12 after extrusion thereof. Second crimped region 42 may be an indentation or an inwardly protruding region of body 12 that defines an inner diameter (see FIG. 3) that is smaller than an inner diameter (see FIG. 3) of body 12. Second crimp 42 may extend into interior 46 of body 12 approximately ⅛ of an inch and may define an angle (see FIG. 2) of approximately 45 degrees with respect to length 36 of body 12. Accordingly, crimps 40 and 42 may retain support structure 44 within interior 46 and between the first and second crimped regions 40 and 42.

Still referring to FIG. 1, assembly 10 further includes a strainer structure 90 including a strainer tube 92, such as a cylindrical strainer tube, placed within body 12, and a strainer end plate 94, such as a circular shaped end plate, placed within body 12 and adjacent support structure 44, wherein end plate 94 may be positioned perpendicular to an elongate axis 88 of body 12. In the embodiment shown, end plate 94 includes a generally circular perimeter shape 96 that defines an outer diameter 98 that is slightly smaller than an inner diameter 58 of body 12. In this manner end plate 94 fits snugly within first end region 14 of body 12 and against first crimp 40. Similarly, strainer tube 92 generally defines a cylinder having two open ends and defines an outer diameter 100 that is slightly smaller than an inner diameter 58 of body 12. In this manner cylindrical tube 92 fits snugly within body 12 and against end plate 94. Body 12 may further include a third crimp 102 that may secure cylindrical tube 92 within body 12 and between first crimp 40 and third crimp 102.

Referring to FIGS. 1 and 4-5, strainer tube 92 and end plate 94 may both include strainer apertures 104 that extend there through, and which allow fuel to flow through the strainer apertures 104 and there after through either of filler tube apertures 30 or support openings 76 of support structure 44 (which may be referred to as filler tube apertures 76 of support structure 44). Strainer apertures 104 generally comprise apertures that are smaller in size than filler tube apertures 30 or support openings 76. In the embodiment shown, strainer apertures 104 may be circular apertures that are stamped into strainer tube 92 and end plate 94 and may define an offset pattern of round holes 104 that define a largest width dimension 108, such as ⅛^{th} inch, that may be at least five times smaller than a largest width dimension 110 of filler tube apertures 30, and in the embodiment shown are approximately ten times smaller than a largest width dimension 110 of filler tube apertures 30. Strainer apertures 104 generally are sized so as to hinder the flow of debris 86 into a fuel tank 52 in which assembly 10 may be mounted. In particular, strainer apertures 104 may be sized to inhibit debris or vandalism materials 86, such as gravel, rocks, sticks, leaves, keys, marbles, or the like, from flowing into a fuel tank on which the assembly 10 is mounted.

Referring again to FIG. 1, strainer tube 92 may also include an enlarged aperture 112 that may be cut into strainer tube 92 through filler tube aperture 30, after strainer tube 92 is secured within filler tube body 12. Enlarged aperture 112 of strainer tube 92 may be utilized to retain an elongate member 114, such as a nylon cord or a chain, through enlarged aperture 104 by use of an anchor 116, such as a wire pin, so as to retain a cap 38 on fuel nozzle opening 54 when the fuel cap is secured to an opposite end of member 114 from anchor 116.

FIG. 2 is a cross-sectional side view of the anti-siphon fuel filler assembly 10 taken along line 2-2 of FIG. 1, and shown installed on a fuel tank 52. In particular, assembly 10 may be installed within a nozzle receptor 54 that is installed in an opening 56 of fuel tank 52. Nozzle receptor 54 may be secured within opening 56 by any means, such as by welding, such that nozzle receptor 54 generally is fixedly secured within opening 56. Outer diameter 22 of anti-siphon assembly 10 may be only slightly smaller than an inner diameter 58 of nozzle receptor 54 such that assembly 10 fits snugly therein. Nozzle receptor 54 may have a length 60 that extends into an interior 62 of fuel tank 52 less than length 36 of anti-siphon assembly 10. Moreover, length 60 of nozzle receptor 54 is generally less than a length 61 of a portion of body 12 that extends from lip 18 to tang 32. Accordingly, when assembly 10 is positioned within nozzle receptor 54, tangs 32 may be memory biased to extend outwardly into interior 62 of fuel tank 52 such that outer diameter 34 of tangs 32 is greater than inner diameter 58 of nozzle receptor 54 thereby retaining anti-siphon assembly 10 in place within nozzle receptor 54.

Still referring to FIG. 2, first crimp 40 and third crimp 102 are shown extending inwardly into interior 46 of body 12 a distance 64 of approximately 1/16 inch. Crimp 42 is shown extending inwardly into interior 46 of body 12 a distance 66 of approximately ⅛ inch and defining an angle 68 of approximately forty-five degrees. In other embodiments, crimps 40, 102 and/or 42 may extend into interior 46 any distance less than the radius or midway point of a cross section of interior 46 such that crimps 40 and/or 42 do not meet one another. In other words, crimps 40, 102 and/or 42 do not completely close off interior 46 of body 12 of assembly 10 but merely act as projections to secure an anti-siphon insert/support structure 44 and strainer structure 90 therein.

Strainer end plate 94 (shown without apertures 104 in this view for ease of illustration) may be positioned upstream of first crimp 40 from support structure 44, i.e., on the other side of crimp 40 from support structure 44. In another embodiment, crimp 40 may be eliminated and end plate 94 may be positioned directly against support structure 44 without a crimp 40 positioned there between. In such an embodiment, second crimp 42 retains support structure 44 in place within body 12, wherein support structure 44 in turn retains end plate 94 in place within body 12.

Strainer tube 92 (shown without apertures 104 in this view for ease of illustration)may be positioned upstream of strainer end plate 94 and downstream of third crimp 102, i.e., strainer tube 92 may be positioned between end plate 94 and third crimp 102. In the embodiment shown, strainer tube 92 abuts end plate 94 and retains end plate 94 in place within body 12 because strainer tube 92 and end plate 94 each define an outer diameter 98 and 100, respectfully, that each define approximately the same dimension.

FIG. 3 is an end view of the anti-siphon fuel filler assembly 10 taken along line 3-3 of FIG. 1. Tang 32 and lip 18 are shown extending outwardly from body 12. End 50 of body 12 is shown having second crimp 42 therein. Support structure 44 is shown secured within interior 46 of body 12 between crimps 40 and 42. Support structure 44 may have a cross sectional shape which may be described as a snowflake or a hub-and-spoke arrangement. The hub-and-spoke shape of support structure 44 may include a central hub 70 having a plurality of spokes 72 extending outwardly therefrom. Central hub 70 may define a support aperture 76 positioned therein and spokes 72 may define a plurality of support apertures 76 positioned therebetween. Apertures or openings 76 may be sized so as to allow fuel and air to easily flow through insert 44, but may be sized so as to prevent insertion of a siphon hose therethrough and into interior 62 of fuel tank 52. The cylindrically symmetrical shape of support structure 44 may add strength and stability to support structure 44 such that support structure 44 may not be easily broken or damaged by a vandal attempting to force a hose into tank 52 or a pry bar into filler assembly 10 to remove the insert therefrom.

Moreover, support structure 44 provides support to strainer end plate 94, thereby allowing for end plate 94 to be manufactured of a relatively thin material. Accordingly, small sized strainer apertures 104 may be manufactured by the cost effective method of stamping a thin sheet of material, because support structure 44 will provide structural support of the end plate 94 and will hinder vandals from dislodging end plate 94 from body 12. Of course, other shapes and designs of support structure 44 may be utilized in other embodiments of the present invention. In still other embodiments, support structure 44 may not be utilized and end plate 94 by itself may be positioned in first end region 14 of body 12. Support structure 44 may be manufactured of aluminum but any durable material such as steel or heavy duty plastic may be utilized.

Support structure 44 typically may have a structure that is symmetrical about a central point of the insert, such as the snowflake or hub-and-spoke shape as shown, such that the insert may be easily manufactured by the process of extrusion. In particular, insert 44 may be extruded as a single, long piece of material and then cut across its cross-section and along its length to define individual inserts 44. Insert 44 generally will have an outer diameter 78 that that is slightly smaller than the inner diameter 80 of body 12 such that insert 44 is snugly received therein. Moreover, the outer diameter 78 of insert 44 generally will be larger than the inner diameter 82 of body 12 at first crimp 40 and the inner diameter 84 of body 12 at second crimp 42 such that support structure 44 may be retained within body 12 between crimps 40 and 42.

Accordingly, the method of the present invention may include: providing an elongate fuel filler tube having a first end region adapted for placement in a fuel tank, the fuel filler tube including filler tube apertures in a side wall thereof; crimping the fuel filler tube in the first end region to define a first crimped region; placing a circular end plate strainer structure in the first end region and adjacent the first crimped region, the circular end plate strainer structure including plate strainer apertures smaller than the filler tube apertures; placing a cylindrical tube strainer structure in the filler tube and adjacent the circular end plate strainer structure, the cylindrical tube strainer structure including cylindrical tube strainer apertures smaller than the filler tube apertures; and crimping the fuel filler tube to define a second crimped region, wherein the circular end plate strainer structure and the cylindrical tube strainer structure are both secured in the fuel filler tube between the first and the second crimps. This process of placing a strainer structure within a fuel filler tube that also includes anti-siphon capabilities, and securing both the anti-siphon insert and the strainer structure within the fuel filler tube with the use of crimps, may result in an anti-siphon and strainer device 10 that is relatively inexpensive to manufacture and assemble yet which provides high strength and reliability.

In the above description numerous details have been set forth in order to provide a more through understanding of the present invention. It will be obvious, however, to one skilled in the art that the present invention may be practiced using other equivalent designs.

We claim:

1. A fuel filler assembly for placement in a fuel tank, comprising:
a filler tube including a first end region adapted to be positioned in a fuel tank, said first end region including an aperture sized to allow fuel to flow through said aperture and out of said filler tube, said filler tube including a first crimp and a second crimp therein;
a support structure positioned within said first end region of said filler tube, said support structure including a plurality of support structure apertures for allowing fuel to flow there through; and
a strainer structure positioned in said filler tube and including strainer apertures extending there though that are sized for allowing fuel to flow there through while inhibiting debris from passing there through, said strainer structure and said support structure both retained within said filler tube by said first and said second crimps.

2. An assembly according to claim 1 wherein said strainer structure includes a cylindrical shaped strainer tube having open ends and wherein said strainer apertures are positioned within a cylindrical side wall of said strainer tube.

3. An assembly according to claim 1 wherein said strainer structure includes an end plate that defines a circular perimeter, said end plate positioned within said filler tube and perpendicular to an elongate axis of said filler tube.

4. An assembly according to claim 1 wherein said strainer structure includes a cylindrical shaped strainer tube having open ends and a sheet of material having a circular perimeter, said cylindrical shaped strainer tube and said circular perimeter sheet of material both having a plurality of said strainer apertures extending there through.

5. An assembly according to claim 4 wherein said sheet of material is positioned within said filler tube and between said cylindrical shaped strainer tube and said first crimp and wherein said cylindrical shaped strainer tube is positioned within said filler tube and between said second crimp and said sheet of material.

6. An assembly according to claim 1 wherein said first and said second crimps are each chosen from a crimp including a plurality of crimped regions positioned around a perimeter of said filler tube and a crimp that extends completely around a perimeter of said filler tube.

7. An assembly according to claim 1 wherein at least one of said first and said second crimps comprises a turned in first end region of said filler tube.

8. An assembly of claim 2 wherein said filler tube includes a plurality of filler tube openings in a side wall thereof, said openings structured to allow fuel to flow there through and out of said filler tube, and wherein a largest width dimension of each of said strainer apertures is at least five times smaller than a largest width dimension of each of said plurality of said filler tube openings.

9. An assembly according to claim 1 wherein said first and said second crimps each define a deflection that extends into an interior of said filler tube.

10. An assembly according to claim 3 wherein a largest width dimension of each of said strainer apertures is at least five times smaller than a largest width dimension of each of said plurality of said support structure apertures.

11. A fuel filler assembly, comprising:
a fuel filler tube adapted for placement in a fuel tank opening, said fuel filler tube including a first open end structured for receiving a fuel nozzle there through, a second open end structured for allowing fuel to flow there through and into a fuel tank in which the fuel filler tube is placed, and a cylindrical side wall including a plurality of filler tube openings structured for allowing fuel to flow there through into a fuel tank in which the fuel filler tube is placed; and
a strainer structure including a cylindrical tube positioned within said fuel filler tube and a circular shaped end plate positioned within said second open end of said fuel filler tube, said cylindrical tube and said circular shaped end plate each including a plurality of strainer structure apertures sized to prevent debris from flowing there through and into a fuel tank in which said fuel filler assembly is placed.

12. A fuel filler assembly according to claim 11 wherein said strainer structure apertures each define a largest width dimension at least five times smaller than a largest width dimension of each of said fuel filler tube openings.

13. A fuel filler assembly according to claim 11 wherein said assembly further comprises a support structure positioned in said second open end of said fuel filler tube, said support structure retaining said circular shaped end plate within said fuel filler tube.

14. A fuel filler assembly according to claim 11 wherein said fuel filler tube includes a first crimp and a second crimp, and wherein said strainer structure is retained within said fuel filler tube by said first and said second crimps.

15. A fuel filler assembly according to claim 11 wherein said strainer structure includes an enlarged strainer structure aperture aligned with one of said fuel filler tube openings, said enlarged strainer structure aperture adapted to receive there through an elongate member for retaining a cap on said fuel filler assembly.

16. A fuel filler assembly accordingly to claim 14 wherein said cylindrical tube is open ended and defines a tube outer diameter, wherein said circular shaped end plate defines a plate outer diameter congruent with said tube outer diameter, and wherein said circular shaped end plate is retained within said filler tube by and between said cylindrical tube and one of said first and said second crimps.

17. A method of manufacturing a fuel filler assembly for placement in a fuel tank, comprising:
providing an elongate fuel filler tube having a first end region adapted for placement in a fuel tank, said fuel filler tube including filler tube apertures in a side wall thereof;
crimping said fuel filler tube in said first end region to define a first crimped region;
placing an end plate strainer structure in said first end region and adjacent said first crimped region, said end plate strainer structure including plate strainer apertures smaller than said filler tube apertures;
placing a tube strainer structure in said filler tube and adjacent said end plate strainer structure, said tube strainer structure including tube strainer apertures smaller than said filler tube apertures; and
crimping said fuel filler tube to define a second crimped region, wherein said end plate strainer structure and said tube strainer structure are both secured in said fuel filler tube between said first and said second crimps.

18. A method according to claim 17, prior to placing said end plate strainer structure in said first end region and adjacent said first crimped region, placing a support structure in said fuel filler tube first end region and adjacent said first crimped region, and thereafter placing said end plate strainer structure in said fuel filler tube and adjacent said support structure.

19. A method according to claim 17 wherein said first and said second crimped regions each define indentations that extend partially into an interior of said fuel filler tube.

20. A method according to claim 17, prior to placing said tube strainer structure in said fuel filler tube, forming a cap chain retaining aperture in a side wall of said tube strainer structure, said cap chain retaining aperture being larger than said tube strainer apertures, and wherein said step of placing said tube strainer structure in said filler tube comprises aligning said cap chain retaining aperture with one of said filler tube apertures.
